(19) United States
(12) Patent Application Publication
(10) Pub. No.: US 2023/0073789 A1
(43) Pub. Date: Mar. 9, 2023

(54) INTERLOCKING ECOLOGICAL ARMORING UNITS AND USES THEREOF IN FORMING A COSTAL BARRIER

(71) Applicant: ECONCRETE TECH LTD, TEL AVIV (IL)

(72) Inventors: IDO SELLA, TEL AVIV (IL); BARAK SAAR, TEL AVIV (IL)

(73) Assignee: ECONCRETE TECH LTD, TEL AVIV (IL)

(21) Appl. No.: 17/800,621

(22) PCT Filed: Feb. 25, 2021
(86) PCT No.: PCT/IL2021/050215

§ 371 Date: Aug. 18, 2022

Related U.S. Application Data
(60) Provisional application No. 62/981,053, filed on Feb. 25, 2020.

(51) Int. Cl. E02B 3/12; A01K 61/77

(52) U.S. Cl. CPC E02B 3/129; A01K 61/77

(57) ABSTRACT

The invention provides a marine infrastructure unit having a polyhedral structure with at least four faces; wherein said unit is formed of concrete and wherein at least one face of said unit comprises at least one tidal pool indentation; for use in building a marine infrastructure and promoting fauna and flora growth in marine environment.

### BACKGROUND OF THE INVENTION

Coastal barriers are the most important depositional elements or geomorphological features of low gradient, wave dominated coasts. They occur worldwide, especially on trailing edge coasts, where coastal topographies are, in general, gentler and where sediments tend to be more abundant. A coastal barrier is a shore parallel structure, formed by an accumulation of sand, gravel, shells, and small amounts of organic material due to the action of waves, tides and winds. It has sub-aerial and sub-aqueous (shoreface) parts, with the first, depending on position, being permanently or partially exposed above sea-level during high tides. There are a large range of types ranging from narrow islands far offshore the mainland to those attached to, and climbing bedrock cliffs. Thus, a barrier can be separated/distinguished from adjacent older land by (i) a lagoon, bay, or wetland, or (ii) by age, lithology and/or form. The literature on coastal barriers is dominated by a particular type of barrier: the barrier island. This is due to the combination of four factors: (i) the barrier island is the most common type of coastal barrier in the USA, especially on the Atlantic and Gulf coasts, (ii) the relative paucity of studies on west coast USA barriers, and other barrier coasts in the past, (iii) many of the pioneer studies on barriers, and particularly barrier islands, were conducted in the USA, and (iv), the great global influence of the North American geological school.

Since the 1980s, the United States Congress recognized that certain actions and programs of the Federal Government have historically subsidized and encouraged development on coastal barriers, resulting in the loss of natural resources; threats to human life, health, and property; and the expenditure of millions of tax dollars each year. To remove the federal incentive to develop these areas, the Coastal Barrier Resources Act (CBRA) of 1982 and subsequent amendments designated relatively undeveloped coastal barriers along the Atlantic, Gulf of Mexico, Great Lakes, U.S. Virgin Islands, and Puerto Rico coasts as part of the John H. Chafee Coastal Barrier Resources System (CBRS), and made these areas ineligible for most new federal expenditures and financial assistance. CBRA encourages the conservation of hurricane prone, biologically rich coastal barriers by restricting federal expenditures that encourage development, such as federal flood insurance.

There is a need for an environmentally compatible units that can be easily transported and interconnected so as to provide strong and ecological coastal infrastructure.

### SUMMARY OF THE INVENTION

Coastal star interlocking ecological armor are units that are fully structural bio-enhanced concrete armor designed to create water retaining elements along riprap, revetment and breakwaters while providing shoreline stabilization. The units create well-defined local ecosystems which mimic natural rock pools, increasing local biodiversity and biological productivity. A total of 72 units are installed on a steep slop riprap along Harbor Island, San Diego, Calif.

The invention provides a concrete polyhedral marine infrastructure unit having at least four faces; wherein at least one face comprises at least one pool indentation for use in promoting fauna and flora growth in aquatic environment.

When referring to a “polyhedral unit” it should be understood to relate to any type of a three-dimensional shape with at least four polygonal faces, straight edges and sharp corners or vertices. The polygonal faces of said unit allow it to be easily interlocking with another polyhedral unit, thereby forming a marine infrastructure. In some embodiments, said unit further comprises at least one carrier hole in at least one face of said polyhedral structure capable of allowing said unit to be carried (for example with a crane) to the location to which it is to be placed.

When referring to “aquatic environment” it should be understood to encompass any type of body of water including, but not limited to marine (including oceanic zones, benthic zones, intertidal zones, neritic zones, estuaries, salt marshes, coral reefs, lagoons and mangrove swamps) and freshwater (including lentic, lotic, wetlands and ponds). The term relates to any depth of said aquatic environment, at any temperature, at any time of year or condition of weather and any flow rates.

In some embodiments marine fauna and flora includes at least one of the following: (i) engineering species such as corals, oysters, serpulid worms, coralline algae and barnacles, that deposit a calcitic skeleton which elevates the structural complexity of the structure and create habitat for other organisms; (ii) filter feeding organisms such as oysters, mussels, tunicates and sponges that feed using filtering organs while in the process uptake nutrients and organic particles from the water; (iii) endolithic/epilithic blue-green algae, and in certain cases when concrete surface is above water level also lichens, fungi and mosses.

When referring to “promotion of fauna and flora growth” it should be understood to encompass any qualitative or quantitative promotion, enhancement, reinforcement, fortification, strengthening, support, recruitment or support of the stability, growth, health and proliferation of fauna and flora either already growing or is capable of growing in aquatic environmental ecosystem, measurable by any parameter known in the art (number of individuals or species, life cycle, coverage of growth or a surface, etc).

In some embodiments said promotion of marine fauna and flora facilitates deposition of inorganic matter on the surface of said structure can reach values between about 50 to 1000 gr/m² after 12 months at a depth range of 1-10 meters. While chlorophyll concentration on the surface of said structure can reach values between about 100 to 800 μgr/m after 12 months at a depth range of 1-10 meters.

In another aspect the invention provides a marine infrastructure comprising at least two units as disclosed herein above and below, each having a polyhedral structure with at least four faces; wherein said each unit is formed of concrete and wherein at least one face of said unit comprises at least one pool indentation

The term “marine construction infrastructure” should be understood to encompass any type, shape or size of an infrastructure that is defined to be suitable for marine construction including coastal defense structures such as breakwaters, seawalls, revetments and groins, bulkheads, piers, berths, coastal barriers, barrier reefs, and related infrastructures such as ports, marinas, waterfronts, promanades etc. Examples of such marine construction infrastructure includes, but is not limited to enhanced sea walls, armoring units, tide pools, piles, bridge bases, seaward berms, concrete mattress, under water cables and pipes casing, mooring units.

The term “concrete” refers to a concrete composition typically comprising at least one type of cement (such as for example Portland cement or Calcium aluminate cements). In some embodiments said concrete further comprises at least one aggregate (such as for example lime stone, blue stone), sand (fine graded aggregate less 4.75 mm and or natural or crashed aggregate less 0-2 mm) and water (potable, and shall not contain more than 1000 parts per million of chlorides or sulfates, free from harmful substances such as lead, copper, zinc (<5 ppm) or phosphates (<5 ppm)).

The term “pool indentation” relate to a relative shallow pool groove made on at least one face of said polyhedral unit of the invention that is capable of receiving seawater when said unit is placed in a marine environment. When said unit is placed in a shore marine environment, such as in coastal barriers or seawalls and so forth, such pool indentation can be a tide pools that exist in the “intertidal zone” (the area within the tidal range), which is submerged by the sea at high tides and during storms and may receive spray from wave action. The intertidal zone is periodically exposed to sun and wind, conditions that can cause barnacles to become desiccated. Tide pools provide a home for hardy organisms such as starfish, mussels and clams. Inhabitants must be able to deal with a frequently changing environment: fluctuations in water temperature, salinity, and oxygen content. Hazards include waves, strong currents, exposure to midday sun and predators. Waves can dislodge mussels and draw them out to sea. Gulls pick up and drop sea urchins to break them open. Starfish prey on mussels and are eaten by gulls themselves. Black bears are known to sometimes feast on intertidal creatures at low tide. Although tide pool organisms must avoid getting washed away into the ocean, drying up in the sun, or being eaten, they depend on the tide pool's constant changes for food.

In a further embodiment the invention provides a method of promoting the growth of endolitic and epilitic flora comprising providing an infrastructure composed of a concrete having a surface pH of less than 12. It is to be noted that such infrastructure may also be terMediterranean bioactive terrestrial structure (i.e. bioactive structure above the water level, however with sufficient humidity and precipitates to promote the growth of terrestrial flora as in natural systems.

The term “endolitic and epilitic flora” should be understood to encompass lichens, fungi, mosses, as well as blue-green algae.

It is to be noted that such endolitic and epilitic flora can be grown in land environments-with sufficient humidity and precipitates. In some embodiments, such infrastructure mentioned herein above is a “bioactive wall” element that is designed to induce rapid plant wall coverage of inland buildings. Green plant coverage significantly improves urban landscape, provides cleaner and healthier air, and reduces the ecological footprint of urban development. The physical and chemical properties of the wall substrates strongly influence its capability to support and enhance growth. In some embodiments such bioactive wall structure induces natural growth of wall clinging plants, endolithic algae, lichens and mosses. In some further embodiments said bioactive wall structure has high complexity and porosity that allows creating moist niches that support flora, without the need for complex soil systems.

In some embodiments said structure mentioned herein above is a “live rock” structure, i.e. a structure according to the invention placed in separated closed marine environments, such as for example aquarium (such as salt water aquarium). Such live rock structures confer to the closed marine environments multiple benefits desired by the saltwater aquarium hobbyist. A live rock structure of the invention provides superior biological filter that hosts both aerobic and anaerobic nitrifying bacteria required for the nitrogen cycle that processes waste. Thus, said live rock becomes the main biological nitrification base or biological filter of a saltwater aquarium. Additionally, a live rock structure of the invention may also have a stabilizing effect on the water chemistry, in particular on helping to maintain constant pH by release of calcium carbonate. Further a live rock structure is a decorative element of the aquarium and provides shelter for the inhabitants.

It is to be noted that promoting the growth of endolitic and epilitic anaerobic and aerobic flora and fauna, such as for example nitrobacter and nitrosomans.

In some embodiments said concrete has a pH of less than about 11. In other embodiments said concrete has a pH of between about 9 to about 10.5. In some embodiments, said pH of said concrete is the pH of substantially the entire concrete infrastructure. In other embodiments said pH of said concrete is the pH substantially the top surface of said infrastructure. In yet further embodiments the thickness of said top surface is about 5 cm or more.

In some embodiments the salinity of said aquatic environment is between about 0 to 45 ppt (i.e. salinity can be 0, 1, 2, 3, 4, 5, 10, 15, 20, 25, 30, 35, 40, 45 ppt).

Enhancement of flora and fauna relates to aquatic environments in areas exposed to sufficient light, i.e., within the photic zone (0-100 meters depth maximum) and in areas from the seabed and up to the splash zone, or above for Bioactive structures that support terrestrial flora.

In some embodiments, said infrastructure has a surface roughness having a roughness grade of at least 12. In other embodiments, said infrastructure has an RA value of at least 50 microns. In addition, said infrastructure has a surface texture with an RA value of at 5-20 mm.

In some other embodiments said concrete has a weight per volume of between about 1100 to about 2500 Kg/m. In yet further embodiments said concrete has a weight per volume of between about 1100 to about 1800 Kg/m.

In further embodiments said concrete comprises with additives and cements in weight between 0 to about 90% of the Portland cement weight or completely replacing it.

In other embodiments said concrete comprises at least one of microsilica/silica fume and metakaolin and Calcium aluminate cements. In some embodiments above noted silica and/or metakaolin and/or calcium alumina cement is added to concrete to replace any equivalent weight % amount of Portland cement. In some further embodiments said concrete has average compressive strength of between about 30 to 80 Mpa (i.e. about 30, 35, 40, 45, 50, 55, 60, 65, 70, 75 or 80 Mpa). (ASTM C 39 (AASHTO T 22))

In some further embodiments said concrete has water pressure penetration resistance of between about 5 to 50 mm under the pressure of 7bar (i.e. about 5, 10, 15, 20, 25, 30, 35, 40,45, 50 mm). (EN 12390-8)

In other embodiments said concrete has chloride penetration resistance of between about 500 to 2000 Coulombs (i.e. about 500, 600, 700, 800, 900, 1000, 1100, 1200, 1300, 1400, 1500, 1600, 1700, 1800, 1900, 2000 Coulombs. (ASTM c 1202).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows the ecological armoring units that create water retaining features along San Diego Port's riprap zone while providing shoreline stabilization.

FIG. 2 shows a cluster of ecological armoring units of the invention which created a well-defined local ecosystem that mimics natural rock pools, increasing biodiversity while providing robust protection from hydrodynamic forces.

FIG. 3 shows the easy transport of ecological armoring units of the invention.

FIG. 4 shows the biological buildup inside the interlocking ecological armoring unit.

FIG. 5 shows the sample unit after 12 months in temperate waters, fully covered by biogenic growth.

FIG. 6 shows the unit of the invention 4 years post deployment flourishing with indigenous marine life.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Resilient shoreline stabilization & ecological uplift through improved design & technology:

The Coastal Star armor can be used for the construction of breakwaters, and revetments providing structural and ecological benefits. In this project, the elements are used to retrofit an existing riprap to provide a fully structural and load bearing section. For optimal performance, the units are placed from the mean high water (MHW) to the mean low water (MLW) in order to promote biogenic buildup of calcium carbonate by organisms such as oysters, tube worms or barnacles which strengthen the structure and add to its stability and longevity. By harnessing biological process to protect the structure(bioprotection), the technology reduced the magnitude and frequency of structural maintenance, which translates into improved ecological stability, as well as a faster and higher ROI.

Support local ecosystems by creating and improving near shore and coastal marine habitats:

With the use of bio-enhancing concrete and scientifically driven design, such as the provision of water retaining elements, the interlocking armor units increase the ability of marine species to settle on the structure. Standard concrete and even rock armor have low surface complexity and dense nature and are not a surrogate to natural rocky marine habitats and often provides limited ecological value to the surrounding environment. The interlocking ecological armor units add valuable water retaining features completely absent from armored shorelines. The units help compensate for the loss of natural intertidal habitats by increasing biodiversity and biological productivity along the structure by accommodating an array of diverse species that are absent from standard rock armoring.

Foster education and stewardship of the Bay through awareness, access, and participation:

By increasing public awareness and fostering education of children and citizen scientists there are a positive impact on the stewardship of San Diego Bay. This enhanced relationship achieved by providing a better understanding of the natural environment by means of offering learning labs and monitoring sessions for local children and adults, along with encouraging recreational activities though increased access. These efforts led to a sustainable increase for the respect of marine habitats and the overall condition of San Diego Bay and continue to progress through the generations.

By integrating environmentally sensitive technologies into the design and construction of coastal and marine infrastructure, the products are able to harness natural processes for ecological enhancement and reduce a structure's ecological footprint. The bio-enhancing concrete products have a reduced carbon footprint compared to Standard Portland cement-based concrete, due to a combination of proprietary admix integrating by-products and recycled materials, and unique ability to enhance biological processes such as biocalcification and photosynthesis which facilitate CO2 assimilation. Biocalcification onto the bio-enhanced units averaged storage of 120 g of Carbon for every square meter of the invention's infrastructure yearly.

Each precast tide pool armor block is 4.1″ (125 cm) high, 375 gal. (1420 liters), and weighs 7500 pounds. 72 units were placed as part of the first stage of the project.

Materials: The Tide Pool Armor units are made using a proprietary concrete admix strengthening compression forces, reducing chloride permeability and reducing the project's CO2 footprint.

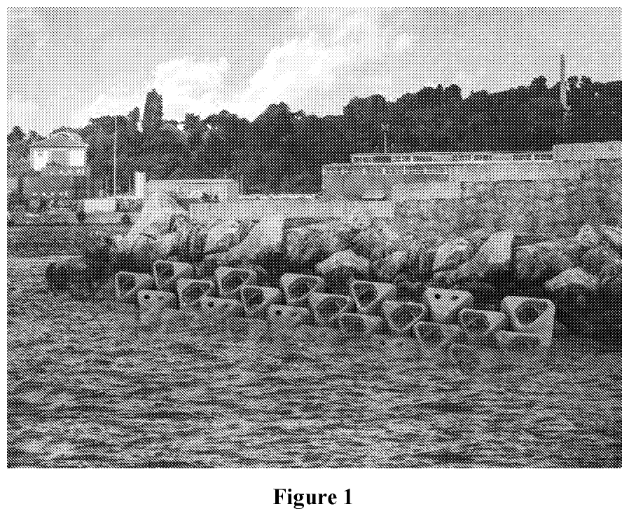

FIG. 1 shows the ecological armoring units that create water retaining features along San Diego Port's riprap zone while providing shoreline stabilization. This water retaining feature accommodates an array of diverse species that are absent in standard rock armoring.

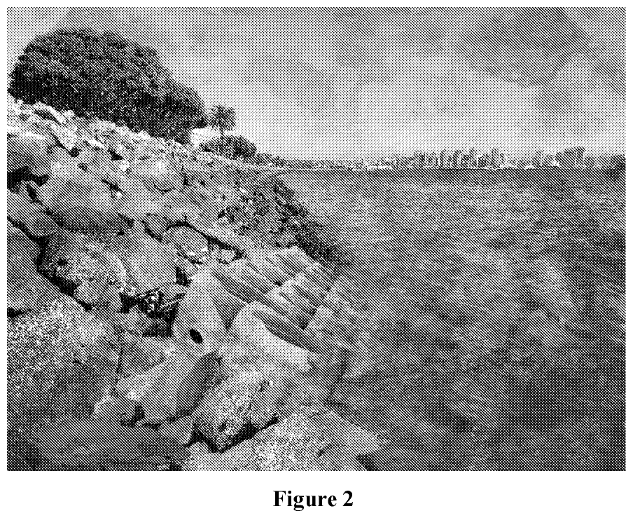

FIG. 2 shows a cluster of ecological armoring units which created a well-defined local ecosystem that mimics natural rock pools, increasing biodiversity while providing robust protection from hydrodynamic forces. The well-defined stepped cavity and texture combined with ECOncrete's proprietary concrete admix provide the ideal habitat for indigenous marine organisms.

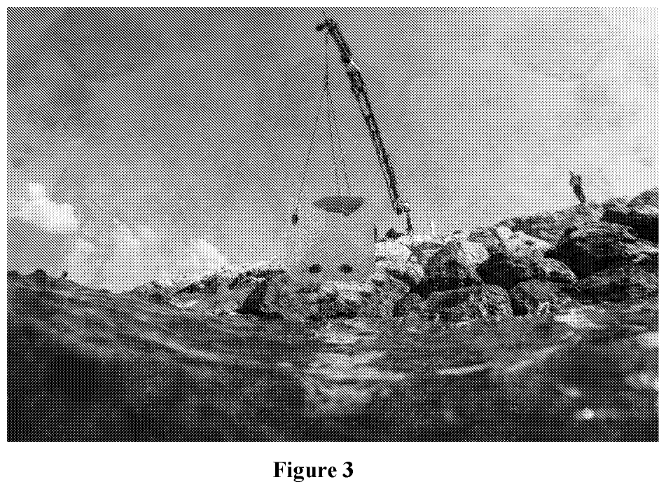

FIG. 3 shows how the ecological armoring units are designed for easy transport and installation.

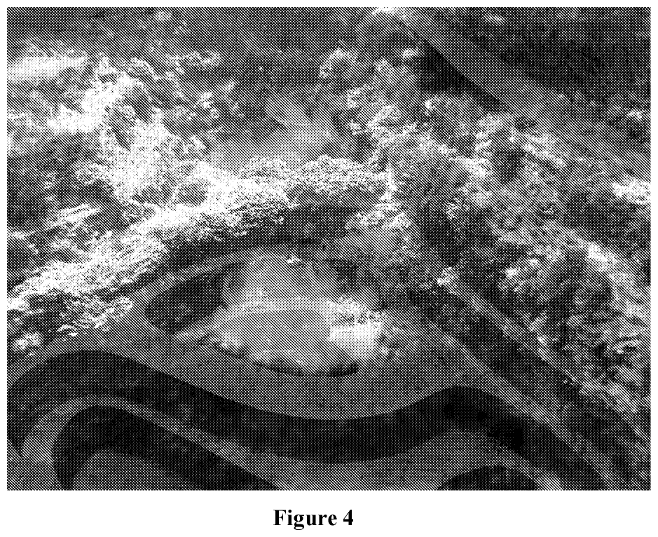

FIG. 4 shows the biological buildup inside the interlocking ecological armoring unit.

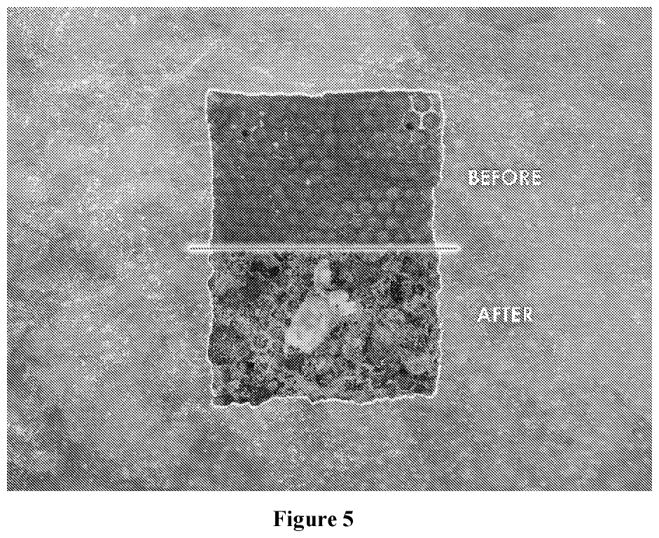

FIG. 5 shows the sample unit after 12 months in temperate waters, fully covered by biogenic growth.

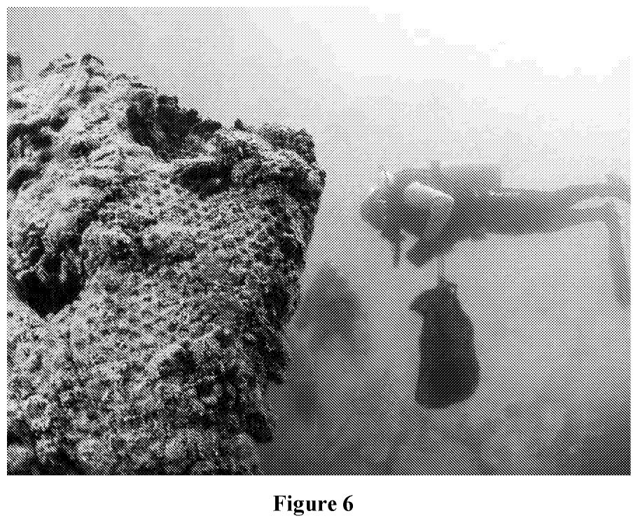

FIG. 6 shows the unit of the invention 4 years post deployment flourishing with indigenous marine life.

The concrete units comply with the strict requirements of coastal and marine construction and allow for simple installation, retrofitting the existing shoreline.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A marine infrastructure unit having a polyhedral structure with at least four faces; wherein said unit is formed of concrete and wherein at least one face of said unit comprises at least one pool indentation; for use in building a marine infrastructure and promoting fauna and flora growth in marine environment.

2. A marine infrastructure unit according to claim 1, wherein said concrete has a pH of less than 12 for use in promoting the growth of fauna and flora in aquatic environment.

3. A marine infrastructure unit according to claim 2, wherein said pH is less than about 11.

4. A marine infrastructure unit according to claim 1, wherein said pH is between about 9 to 10.5.

5. A marine infrastructure unit according to claim 1 wherein said concrete comprises between 0 to about 90% of the Portland cement.

6. A marine infrastructure unit according to claim 1, wherein said concrete comprises at least one of microsilica/silica fume and Metakaolin and/or Calcium aluminate cements.

7. A marine infrastructure unit according to claim 1, wherein said concrete has average compressive strength of between about 30 to 80 Mpa.

8. A marine infrastructure unit according to claim 1, wherein said concrete present water penetration depth under 7 bar of between about 5 to 50 mm.

9. A marine infrastructure unit according to claim 1, wherein said concrete has chloride penetration resistance of between about 500 to 2000 Coulombs.

10. A marine infrastructure unit according to claim 1, wherein marine fauna and flora is selected from engineering and habitat forming species and corals and filter feeding organisms.

11. A marine infrastructure comprising at least two units according to claim 1, each having a polyhedral structure with at least four faces; wherein said each unit is formed of concrete and wherein at least one face of said unit comprises at least one pool indentation.
